(19) United States
(12) Patent Application Publication
(10) Pub. No.: US 2021/0079559 A1
(43) Pub. Date: Mar. 18, 2021

(54) MODIFIED CROSS-SECTION FIBER AND METHOD FOR MANUFACTURING SAME AND NONWOVEN FABRIC AND NOISE-ABSORBING AND -INSULATING MATERIAL COMPRISING MODIFIED CROSS-SECTION FIBER

(71) Applicant: Mitsubishi Chemical Corporation, Tokyo (JP)

(72) Inventor: Tatsuhiko INAGAKI, Tokyo (JP)

(73) Assignee: Mitsubishi Chemical Corporation, Tokyo (JP)

(21) Appl. No.: 17/104,280

(22) Filed: Nov. 25, 2020

Related U.S. Application Data
(63) Continuation of application No. PCT/JP2019/021009, filed on May 28, 2019.

(30) Foreign Application Priority Data
May 29, 2018 (JP) 2018-102509

(51) Int. Cl. D01D 5/253; D04H 3/018; E04B 1/84

(52) U.S. Cl. CPC D01D 5/253; D06M 2101/32; E04B 1/8409; D04H 3/018

(57) ABSTRACT

The invention provides a modified cross-section fiber is provided having a single fiber fineness of 0.01 to 1.0 dtex and modified cross-section degree (α, α=P/(4πA)^{1/2}, where P represents a peripheral length (μm) in a fiber cross section, and A represents an area of the fiber cross section (μm²)) of 1.5 to 4.0 at a fiber cross section taken along a direction perpendicular to the fiber axis.

This application is a continuation filing of, and claims priority under 35 U.S.C. § 111(a) to, International Application No. PCT/JP2019/021009, filed May 28, 2019, and claims priority therethrough under 35 U.S.C. § 119 to Japanese Patent Application No. 2018-102509, filed May 29, 2018, the entireties of which are incorporated herein by reference.

### BACKGROUND OF THE INVENTION

### Field of the Invention

The present invention relates to a modified cross-section fiber, a method for manufacturing the same, and a nonwoven fabric and a noise-absorbing and -insulating material containing the modified cross-section fiber.

### Description of the Related Art

Microfibers each having a diameter of a few micrometers have a delicate and soft texture in a case where made into fabrics. Therefore, they are widely used as wiping cloths and suede-like fabrics. Meanwhile, owing to their large specific surface area, the microfibers exhibit a collection effect or high acoustic resistance. Accordingly, the microfibers are also used for industrial use such as a filter or a noise-absorbing material.

One of the methods for manufacturing the microfibers is a method of selectively removing a sea component from an islands-in-sea fiber in which poorly soluble island components are contained in the sea component formed of an easily soluble polymer (Japanese Patent Application Publication No. 2004-293008).

In a case where a thermoformed press felt nonwoven fabric is mainly used as a noise-absorbing material, sometimes a modified cross-section fiber is used to improve the rigidity of the nonwoven fabric (Japanese Patent Application Publication No. 2017-197894). In Japanese Patent Application Publication No. 2017-197894, in improving the rigidity of the nonwoven fabric, for the purpose of improving noise-absorbing and -insulating performance by maintaining the thickness, a modified cross-section fiber having a high fineness is used.

### SUMMARY OF THE INVENTION

### Technical Problem

It cannot be said that the nonwoven fabric using the modified cross-section fiber having a high fineness in Japanese Patent Application Publication No. 2017-197894 demonstrates fully satisfactory noise-absorbing and -insulating performance.

However, with the conventional method, it is difficult to manufacture ultrafine modified cross-section fibers. For example, the method described in Japanese Patent Application Publication No. 2004-293008 requires a step of manufacturing an islands-in-sea composite fiber first and then removing the sea component by using a solubilizer. This method is applicable to limited types of products. In addition, in manufacturing microfibers by a spinning method (direct spinning) in which a spinning dope is discharged from a spinning nozzle, due to the substantial influence of foreign substances in the spinning dope, the resistance of a spinning guide, and the like, yarn breakage easily occurs. Therefore, with this method, only some fibers having a certain fineness can be stably produced. Particularly, there are problems in that the modified cross-section fiber is significantly affected by yarn breakage, and a shaped spinneret having a small diameter needs to be manufactured.

An object of the present invention is to provide a modified cross-section fiber having a low fineness and a nonwoven fabric and a noise-absorbing and -insulating material using the modified cross-section fiber.

### Solution to Problem

The gist of the present invention is as follows.

[1] A modified cross-section fiber having a single fiber fineness of 0.01 to 1.0 dtex and modified cross-section degree (α) of 1.5 to 4.0 at a fiber cross section taken along a direction perpendicular to a fiber axis, in which the non-circularity degree is calculated by Equation (1).

α=P/(4πA)^{1/2} (1)

In the equation, P is a peripheral length (unit: μm) of the fiber cross section, and A is an area of the fiber cross section (unit: μm²).

[2] The modified cross-section fiber in [1], in which the area (A) of the fiber cross section is 0.5 to 100 μm², and the peripheral length (P) of the fiber cross section is 5 to 250 μm.

[3] The modified cross-section fiber in [1] or [2], in which the fiber cross section is Y-shaped, cross-shaped, 6-lobed, 8-lobed, or pinwheel-shaped.

[4] The modified cross-section fiber in any one of [1] to [3], which is a polyester fiber, a polypropylene fiber, a nylon fiber, an aramid fiber, an acrylic fiber, or a rayon fiber.

[5] The modified cross-section fiber in any one of [1] to [4] having a noise absorption coefficient equal to or higher than 0.40 at a frequency of 400 to 1,250 Hz, in which the noise absorption coefficient is measured in the following noise-absorbing and -insulating performance test (I).

(Noise-Absorbing and -Insulating Performance Test (I))

The fiber (0.81 g) is cut in a length of 40 mm and put in a cylindrical holder having a diameter of 41.5 mm and a thickness of 30 mm, a normal incidence noise absorption coefficient at a frequency of 400 to 1,250 Hz is measured, and an average of the coefficient is calculated.

[6] The modified cross-section fiber in any one of [1] to [4] having a noise absorption coefficient equal to or higher than 0.17 at a frequency of 400 to 1,250 Hz, in which the noise absorption coefficient is measured in the following noise-absorbing and -insulating performance test (II).

(Noise-Absorbing and -Insulating Performance Test (II))

The fiber (0.27 g) is cut in a length of 40 mm and put in a cylindrical holder having a diameter of 41.5 mm and a thickness of 20 mm, a normal incidence noise absorption coefficient at a frequency of 400 to 1,250 Hz is measured, and an average of the coefficient is calculated.

[7] The modified cross-section fiber in any one of [1] to [6] having a transmission loss equal to or higher than 5.1 dB at a frequency of 400 to 5,000 Hz, in which the transmission loss is measured in the following noise-absorbing and -insulating performance test (III).

(Noise-Absorbing and -Insulating Performance Test (III))

The modified cross-section fiber (70% by mass) having a fiber length of 40 mm is mixed with 30% by mass of a polyester melting fiber having a single fiber fineness of 2.2 dtex, a fiber length of 51 mm, and a melting point of 110° C., the mixture is heated at 170° C. for 20 minutes and then cooled so that a nonwoven fabric for test having a thickness of 10 mm and a basis weight of 480 g/m² is obtained, a normal incidence transmission loss of the obtained nonwoven fabric for test at a frequency of 400 to 5,000 Hz is measured, and an average of the normal incidence transmission loss is calculated.

[8] A method for manufacturing a modified cross-section fiber, including obtaining a fibrous substance by discharging of a fiber raw material from a discharge hole which has a discharge hole area of 100 to 3,000 μm² and has a shape satisfying modified cross-section degree (α′) of 1.5 to 4.0 calculated by Equation (2), and setting a single fiber fineness of the fibrous substance to be 0.01 to 1.0 dtex.

α′=P′/(4πA′)^{1/2} (2)

In the equation, P′ is a peripheral length (unit: μm) of the shape of the discharge hole, and A′ is the discharge hole area (unit: μm²).

[9] A nonwoven fabric containing 10% by mass or more of the modified cross-section fiber in any one of [1] to [7].

[10] The nonwoven fabric in [9] having a basis weight of 100 to 500 g/m² and a thickness of 3 to 30 mm.

[11] The nonwoven fabric in [9] or [10] having an average normal incidence transmission loss equal to or higher than 5.1 dB at a frequency of 400 to 5,000 Hz.

[12] The nonwoven fabric in any one of [9] to [11], containing 10% to 90% by mass of the modified cross-section fiber and 10% to 40% by mass of a melting fiber, in which a total content of the modified cross-section fiber and the melting fiber is 20% to 100% by mass.

[13] A noise-absorbing and -insulating material containing 10% by mass or more of the modified cross-section fiber in any one of [1] to [7].

[14] A noise-absorbing and -insulating material containing 50% by mass or more of the nonwoven fabric in any one of [9] to [12].

### Advantageous Effects of Invention

The modified cross-section fiber of the present invention is suitable as a material of a nonwoven fabric having excellent noise-absorbing performance and excellent noise-insulating performance (noise-absorbing and -insulating performance).

The method for manufacturing a modified cross-section fiber of the present invention makes it possible to manufacture a modified cross-section fiber having a low fineness by direct spinning.

The nonwoven fabric of the present invention has excellent noise-absorbing and -insulating performance.

The noise-absorbing and -insulating material of the present invention has excellent noise-absorbing and -insulating performance.

### BRIEF DESCRIPTION OF THE DRAWINGS

FIG. 1 is a view showing an example a 6-lobed discharge hole according to the method for manufacturing a modified cross-section fiber of the present invention.

FIG. 2 is a view showing an example of a pinwheel-shaped discharge hole according to the method for manufacturing a modified cross-section fiber of the present invention.

FIG. 3 is a photomicrograph showing an example of a modified cross-section fiber according to the present invention that has a 6-lobed cross section.

FIG. 4 is a photomicrograph showing an example of a modified cross-section fiber according to the present invention that has a pinwheel-shaped cross section.

### DETAILED DESCRIPTION OF THE INVENTION

In the present specification, “transmission loss” means “normal incidence transmission loss”. The normal incidence transmission loss is measured by a method based on ASTM E2611 “Transmission loss at a frequency of 400 to 5,000 Hz” means “average normal incidence transmission loss at 400 to 5,000 Hz”. The same shall be applied to the transmission loss in other frequency bands.

In the present specification, “noise absorption coefficient” means “normal incidence noise absorption coefficient”. The normal incidence noise absorption coefficient is measured by a method based on JIS A 1405-2. A noise absorption coefficient of 1 indicates that all sounds are absorbed. A noise absorption coefficient of 0 indicates that all sounds are reflected. “Noise absorption coefficient at a frequency of 400 to 1,250 Hz” means “average noise absorption coefficient at 400 to 1,250 Hz”. The same shall be applied to the noise absorption coefficient in other frequency bands.

Hereinafter, embodiments of the present invention will be described.

### First Embodiment: Modified Cross-Section Fiber

The modified cross-section fiber of the present embodiment has a single fiber fineness of 0.01 to 1.0 dtex.

In a case where the single fiber fineness is equal to or higher than 0.01 dtex, the fiber has excellent handleability and excellent spinnability, and the manufacturing cost does not increase too much. In a case where the single fiber fineness is equal to or lower than 1.0 dtex, the fiber has excellent noise-absorbing and -insulating performance. From these viewpoints, the single fiber fineness is more preferably 0.05 to 0.8 dtex, and even more preferably 0.1 to 0.6 dtex.

The modified cross-section fiber of the present embodiment has modified cross-section degree α of 1.5 to 4.0. In a case where P represents a peripheral length (unit: μm) of a fiber cross section taken along a direction perpendicular to a fiber axis, and A represents an area (unit: μm²) of the fiber cross section, the non-circularity degree α is calculated by Equation (1).

α=P/(4πA)^{1/2} (1)

In a case where the non-circularity degree α is equal to or higher than 1.5, the ratio of the peripheral length of the fiber cross section to the area of the fiber cross section is increased, and the specific surface area is enlarged. Therefore, excellent noise-absorbing and -insulating performance is obtained. In a case where the non-circularity degree α is equal to or lower than 4.0, the guide resistance resulting from the large specific surface area is reduced, and excellent spinnability is obtained.

The non-circularity degree α is preferably 1.7 to 3.7, and more preferably 1.9 to 3.5.

The area of the cross section (hereinafter, also called “cross-sectional area”) of the modified cross-section fiber of the present embodiment is preferably 0.5 to 100 μm².

In a case where the cross-sectional area is equal to or larger than 0.5 μm², the fiber has excellent handleability and excellent spinnability, and the manufacturing cost does not increase too much. In a case where the cross-sectional area is equal to or smaller than 100 μm², excellent noise-absorbing and -insulating performance is obtained. From these viewpoints, the cross-sectional area is more preferably 1.5 to 75 μm², and even more preferably 5 to 50 μm².

The peripheral length of the cross section of the modified cross-section fiber of the present embodiment is preferably 5 to 250 μm.

In a case where the peripheral length is equal to or greater than 5 μm, the fiber has excellent handleability and excellent spinnability, and the manufacturing cost does not increase too much. In a case where the peripheral length is equal to or smaller than 250 μm, excellent noise-absorbing and -insulating performance is obtained. From these viewpoints, the peripheral length is more preferably 8 to 200 μm, and even more preferably 30 to 150 μm.

The cross-sectional shape of the modified cross-section fiber of the present embodiment is not particularly limited as long as the cross section has modified cross-section degree of 1.5 to 4.0. However, it is preferable that the modified cross-section fiber have a multilobed cross-sectional shape. “Multilobed” means that the cross section has projections arranged along a circumferential direction at intervals. For example, in view of easily increasing the ratio of peripheral length P/cross-sectional area A and easily obtaining excellent spinnability, it is preferable that the fibber have a Y-shaped cross section having 3 projections, a cross-shaped cross section having 4 projections, a 6-lobed cross section having 6 projections, an 8-lobed cross section having 8 projections, or a pinwheel-shaped cross section having 3 to 8 curved projections.

As the material of the modified cross-section fiber of the present embodiment, synthetic fibers such as a polyester fiber, a polypropylene fiber, a nylon fiber, an aramid fiber, and an acrylic fiber, semi-synthetic fiber such as acetate and promix, and regenerated fibers such as rayon and cupra can be suitably used, but the material is not particularly limited.

Among these, a polyester fiber, a polypropylene fiber, a nylon fiber, an aramid fiber, an acrylic fiber, or a rayon fiber is preferable.

Particularly, from the viewpoint of weight reduction, an acrylic fiber, a nylon fiber, or a polypropylene fiber having a low specific gravity is suitable. From the viewpoint of noise absorptivity or fine fiber productivity, an acrylic fiber is more suitable.

It is preferable that the modified cross-section fiber of the present embodiment have a noise absorption coefficient (hereinafter, also called “noise absorption coefficient (I)”) equal to or higher than 0.40 at a frequency of 400 to 1,250 Hz, which is measured in the following noise-absorbing and -insulating performance test (I). In a case where the noise absorption coefficient (I) is equal to or higher than 0.40, the engine noise or roadway noise can be easily prevented. The wavelength of engine noise or roadway noise is around 1,000 Hz. The noise absorption coefficient (I) is preferably 0.42 to 1, and more preferably 0.45 to 1.

(Noise-Absorbing and -Insulating Performance Test (I))

The fiber (0.81 g) is cut in a length of 40 mm and put in a cylindrical holder having a diameter of 41.5 mm and a thickness of 30 mm, and a normal incidence absorption coefficient at a frequency of 400 to 1,250 Hz is measured, and an average of the coefficient is calculated.

It is preferable that the modified cross-section fiber of the present embodiment have a noise absorption coefficient (hereinafter, also called “noise absorption coefficient (II)”) equal to or higher than 0.17 at a frequency of 400 to 1,250 Hz, which is measured in the following noise-absorbing and -insulating performance test (II). In a case where the noise absorption coefficient (II) is equal to or higher than 0.17, the engine noise or roadway noise can be easily prevented. The wavelength of engine noise or roadway noise is around 1,000 Hz. The noise absorption coefficient (II) is preferably 0.18 to 1, and more preferably 0.19 to 1.

(Noise-Absorbing and -Insulating Performance Test (II))

The fiber (0.27 g) is cut in a length of 40 mm and put in a cylindrical holder having a diameter of 41.5 mm and a thickness of 20 mm, a normal incidence absorption coefficient at a frequency of 400 to 1,250 Hz is measured, and an average of the coefficient is calculated.

It is preferable that the modified cross-section fiber of the present embodiment have a transmission loss (hereinafter, also called “transmission loss (III)”) equal to or higher than 5.1 dB at a frequency of 400 to 5,000 Hz, which is measured in the following noise-absorbing and -insulating performance test (III). In a case where the transmission loss (III) is equal to or higher than 5.1 dB, an excellent noise-insulating effect is obtained. The upper limit of the transmission loss (III) is not particularly limited, and the higher the transmission loss (III), the better. In a case where the upper limit of the transmission loss (III) is 20 dB, a sufficient noise-absorbing and -insulating effect is obtained.

The transmission loss (III) is more preferably equal to or higher than 5.3 dB, even more preferably equal to or higher than 5.5 dB, and particularly preferably equal to or higher than 5.7 dB. Even though the upper limit is equal to or lower than 15 dB, an excellent effect is obtained. Even though the upper limit is equal to or lower than 10 dB, the effect is still exerted.

From these viewpoints, the transmission loss (III) is preferably 5.1 to 20 dB, more preferably 5.3 to 20 dB, even more preferably 5.5 to 20 dB, and particularly preferably 5.7 to 20 dB.

The transmission loss (III) may be 5.1 to 15 dB, 5.3 to 15 dB, 5.5 to 15 dB, or 5.7 to 15 dB.

The transmission loss (III) may be 5.1 to 10 dB, 5.3 to 10 dB, 5.5 to 10 dB, or 5.7 to 10 dB.

(Noise-Absorbing and -Insulating Performance Test (III))

The modified cross-section fiber to be tested is cut in a fiber length of 40 mm, thereby preparing cut fibers. In addition, a polyester melting fiber having a single fiber fineness of 2.2 dtex, a fiber length of 51 mm, and a melting point of 110° C. is prepared.

The modified cross-section fiber (70% by mass) having a fiber length of 40 mm is mixed with 30% by mass of the polyester melting fiber, the mixture is heated at 170° C. for 20 minutes and then cooled, thereby preparing a nonwoven fabric for test having a thickness of 10 mm and a basis weight of 480 g/m². For the obtained nonwoven fabric for test, a transmission loss and a noise absorption coefficient at a frequency of 400 to 5,000 Hz are measured, and the average transmission loss and average noise absorption coefficient are calculated.

From the viewpoint of the noise-absorbing effect and the shape of the noise-absorbing material, the noise absorption coefficient at a frequency of 400 to 5,000 Hz that is measured in the noise-absorbing and -insulating performance test (III) is preferably 0.2 to 1, and more preferably 0.3 to 1.

<Method for Manufacturing Modified Cross-Section Fiber>

The modified cross-section fiber of a first embodiment can be manufactured by a method including the steps of obtaining a fibrous substance by discharging of a fiber raw material from a discharge hole and adjusting a single fiber fineness of the fibrous substance to be 0.01 to 1.0 dtex. Specifically, the fibrous substance is obtained by discharging of a fiber raw material into a coagulation bath from a discharge hole of a spinning nozzle, and then the single fiber fineness of the fibrous substance is adjusted as necessary. The single fiber fineness of the fibrous substance can be adjusted by a method of stretching the fibrous substance.

It is preferable to design the discharge hole so that the cross-sectional shape of the fibrous substance is the same as or larger than the cross-sectional shape of the modified cross-section fiber to be obtained.

Specifically, the area of the discharge hole (opening area) is preferably 100 to 3,000 μm², and modified cross-section degree α′ of the discharge hole shape that is calculated by Equation (2) is preferably 1.5 to 4.0.

α′=P′/(4πA′)^{1/2} (2)

In the equation, P′ is a peripheral length (unit: μm) of the discharge hole shape, and A′ is a discharge hole area (unit: μm²).

In a case where the discharge hole area is equal to or larger than 100 μm², it is easy to obtain a modified cross-section fiber having a single fiber fineness equal to or higher than 0.01 dtex. In a case where the discharge hole area is equal to or smaller than 3,000 μm², it is easy to obtain a modified cross-section fiber having a single fiber fineness equal to or lower than 1.0 dtex. From these viewpoints, the discharge hole area is preferably 200 to 2,500 μm², and more preferably 250 to 2,000 μm².

In a case where the non-circularity degree α′ of the discharge hole shape is equal to or higher than 1.5, it is easy to obtain a modified cross-section fiber having modified cross-section degree α equal to or higher than 1.5. In a case where the non-circularity degree α′ of the discharge hole shape is equal to or lower than 4.0, it is easy to obtain a modified cross-section fiber having modified cross-section degree a equal to or lower than 4.0.

It is preferable to design the discharge hole shape so that the cross-sectional shape of the fibrous substance is similar to but larger than the cross-sectional shape of the modified cross-section fiber to be obtained.

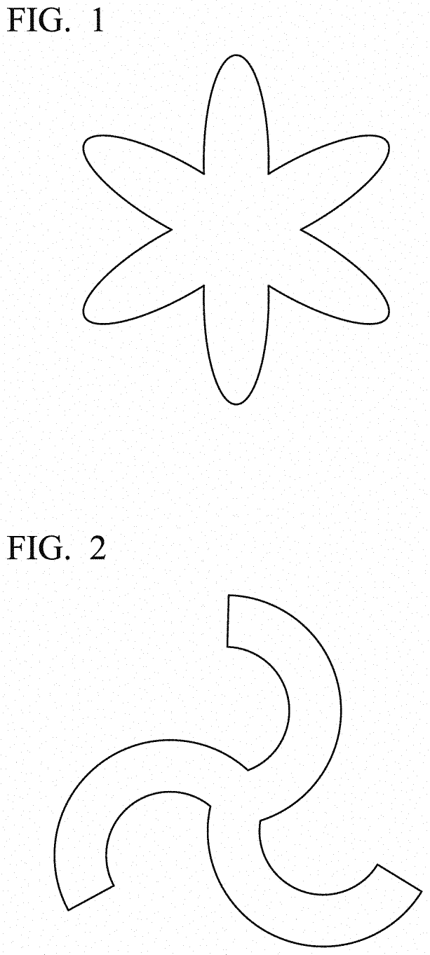

It is preferable that the discharge hole have a multilobed shape. The multilobed discharge hole is preferably Y-shaped, cross-shaped, 6-lobed, 8-lobed, or pinwheel-shaped. FIGS. 1 and 2 are examples of multilobed discharge holes. FIG. 1 is an example of the 6-lobed discharge hole which has 6 projections arranged in the circumferential direction at equal intervals and has modified cross-section degree α of 2.07. FIG. 2 is an example of the pinwheel-shaped discharge hole which has 3 curved projections arranged in the circumferential direction at equal intervals and has modified cross-section degree α of 2.27.

The fiber raw material described above is preferably a spinning dope obtained by dissolving a polymer constituting a fiber in a solvent.

The concentration of solid content of the spinning dope is preferably 10% to 30% by mass, more preferably 13% to 28% by mass, and even more preferably 15% to 25% by mass. In a case where the concentration of solid content is equal to or higher than the lower limit of the above range, the solvent in the coagulation bath is rapidly replaced. Therefore, yarn breakage hardly occurs. In a case where the concentration of solid content is equal to or lower than the upper limit of the above range, the viscosity of the spinning dope does not increase too much.

Hereinafter, the method for manufacturing a modified cross-section fiber will be specifically described by using acrylic fiber for example. In the present specification, the acrylic fiber means a fiber formed of a copolymer of acrylonitrile and an unsaturated monomer capable of being polymerized with acrylonitrile (acrylonitrile-based polymer).

As the unsaturated monomer, it is possible to use acrylic acid, methacrylic acid, alkyl esters of these, vinyl acetate, acrylamide, vinyl chloride, vinylidene chloride. Furthermore, depending on the purpose, it is possible to use ionic unsaturated monomers such as sodium vinyl benzene sulfonate, sodium methallyl sulfonate, sodium allyl sulfonate, sodium acrylamide methylpropane sulfonate, and sodium p-sulfophenyl metallyl ester. One kind of each of these unsaturated monomers may be used singly, or two or more kinds of these unsaturated monomers may be used in combination.

The content of acrylonitrile units with respect to the total content of monomer units constituting the polymer is preferably equal to or higher than 80% by mass, and more preferably equal to or higher than 85% by mass. The upper limit thereof is preferably equal to or lower than 99% by mass.

For example, the content of the acrylonitrile units is preferably 80% to 99% by mass, and more preferably 85% to 99% by mass.

The acrylic fiber may be constituted with one kind of acrylonitrile-based polymer or a mixture of two or more kinds of acrylonitrile-based polymers with different acrylonitrile unit contents.

The polymerization method of the acrylonitrile-based polymer is not particularly limited, and examples thereof include suspension polymerization, solution polymerization, and the like. The molecular weight of the acrylonitrile-based polymer is not particularly limited as long as it is within a range usually adopted for manufacturing acrylic fibers. For example, a dimethylformamide solution having a polymer concentration of 0.5% by weight preferably has a reduced viscosity of 1.5 to 3.0 at 25° C. (hereinafter, also called “reduced viscosity of diluted solution (0.5%)”). In a case where the molecular weight of the acrylonitrile-based polymer is too low, the spinnability tends to deteriorate and the quality of raw yarn also tends to worsen. In a case where the molecular weight is too high, the polymer concentration at which the spinning dope has optimal viscosity tends to be lowered, and the productivity tends to deteriorate. It is preferable to select the molecular weight of the acrylonitrile-based polymer according to the spinning conditions so as prevent the occurrence of the above problems.

The spinning dope is prepared by dissolving the acrylonitrile polymer in a solvent. At this time, the content (polymer concentration) of the acrylonitrile-based polymer with respect to the total mass of the spinning dope is set to be 10% to 30% by mass. In a case where the polymer concentration is equal to or higher than 10% by mass, there is no substantial difference between the discharge hole shape and the cross-sectional shape of the fibrous substance obtained after coagulation, and it is easy to control the cross-sectional shape of the modified cross-section fiber. In a case where the polymer concentration is equal to or lower than 30% by mass, the spinning dope has excellent temporal stability, and excellent spinning stability is obtained.

As the solvent, it is possible to use an organic solvent such as dimethylformamide, dimethylacetamide, or dimethyl sulfoxide; and an inorganic solvent such as nitric acid, an aqueous rhodanate solution, or an aqueous zinc chloride solution. In view of easily controlling the cross-sectional shape of the modified cross-section fiber by the discharge hole shape, an organic solvent is preferable.

The concentration of the aqueous solution of the solvent used as the coagulation bath is preferably 25% to 50% by mass. The temperature of the coagulation bath is preferably 20° C. to 60° C.

In a case where the spinning draft defined by the ratio between the take-up speed of the fibrous substance obtained after solidification and the linear velocity of discharge of the spinning dope is 0.7 to 3.0, it is easy to maintain an excellent spinning state. In a case where the spinning draft is equal to or higher than 0.7, there is no substantial difference between the discharge hole shape and the cross-sectional shape of the fibrous substance obtained after coagulation. Therefore, it is easy to obtain the desired cross-sectional shape and to suppress cross-sectional unevenness. In a case where the spinning draft is equal to or lower than 3.0, it is easy to inhibit the occurrence of yarn breakage in the coagulation bath, and excellent manufacturing stability is obtained.

If necessary, the obtained fibrous substance is stretched by a known method so that the single fiber fineness is adjusted to 0.01 to 1.0 dtex. In addition, if necessary, the fibrous substance is subjected to, for example, a washing, drying, or relaxation treatment. The obtained fiber can be made into raw stock by being cut in a predetermined length according to the use.

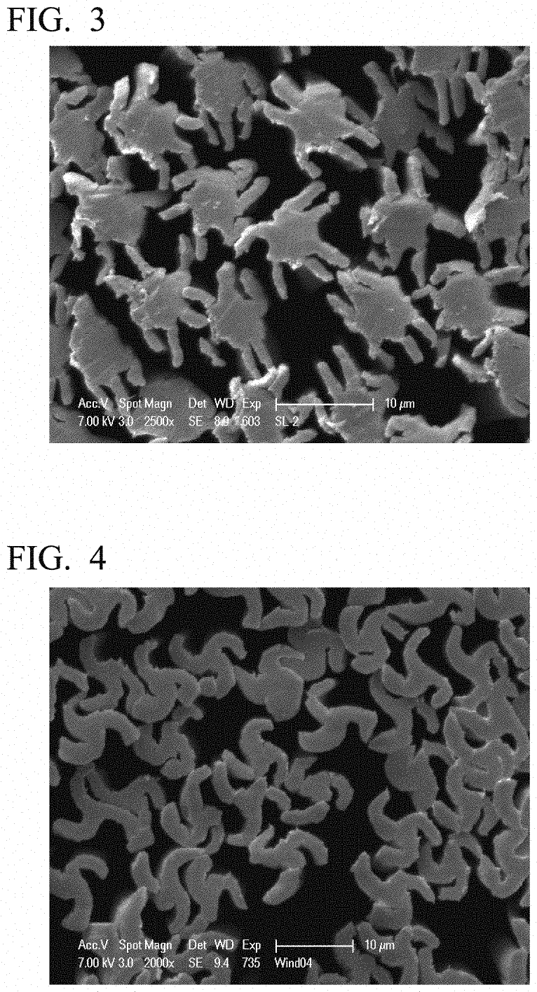

FIG. 3 is a photomicrograph showing an example of a modified cross-section fiber having a 6-lobed cross section. FIG. 4 is a photomicrograph showing an example of a modified cross-section fiber having a pinwheel-shaped cross section.

### Second Embodiment: Nonwoven Fabric

The nonwoven fabric of the present embodiment contains 10% by mass or more of the modified cross-section fiber of the first embodiment.

In a case where the single fiber fineness of the modified cross-section fiber is equal to or higher than 0.01 dtex, the nonwoven fabric has excellent strength. In a case where the single fiber fineness is equal to or lower than 1.0 dtex, the nonwoven fabric has excellent noise-absorbing and -insulating performance. From these viewpoints, the single fiber fineness is more preferably 0.05 to 0.8 dtex, and even more preferably 0.1 to 0.6 dtex.

In a case where the non-circularity degree α of the modified cross-section fiber is equal to or higher than 1.5, the specific surface area is increased, and the nonwoven fabric has excellent noise-absorbing and -insulating performance. In a case where the non-circularity degree α is equal to or lower than 4.0, excellent processability is obtained in a case where the nonwoven fabric is processed.

In a case where the content rate of the modified cross-section fiber in the nonwoven fabric is equal to or higher than 10% by mass, the noise-absorbing and -insulating performance brought about by the modified cross-section fiber contained in the nonwoven fabric is effectively and fully improved. In view of noise-absorbing and -insulating performance, it is preferable that the content rate of the modified cross-section fiber be high. The content rate of the modified cross-section fiber may be 100% by mass.

From these viewpoints, the content rate of the modified cross-section fiber in the nonwoven fabric is preferably 30% to 100% by mass, more preferably 50% to 100% by mass, and most preferably 60% to 100% by mass.

In view of formability, the nonwoven fabric may contain another fiber as long as desired noise-absorbing and -insulating performance can be obtained.

For example, the content rate of the modified cross-section fiber in the nonwoven fabric may be 10% to 90% by mass or 10% to 70% by mass.

The content rate of the modified cross-section fiber in the nonwoven fabric may be 30% to 90% by mass, 30% to 70% by mass, 50% to 90% by mass, 50% to 70% by mass, 60% to 90% by mass, or 60% to 70% by mass.

The nonwoven fabric may contain a melting fiber as another fiber. The melting fiber is a fiber having a melting point lower than that of the modified cross-section fiber. For example, a polyester fiber having a melting point of 100° C. to 130° C. is suitably used.

The nonwoven fabric can be manufactured by a method of heating a mixture of the modified cross-section fiber and the melting fiber to a temperature at which the melting fiber is thermally melted and then cooling the mixture.

The content rate of the melting fiber in the nonwoven fabric is preferably 10% to 40% by mass, and more preferably 20% to 35% by mass. In a case where the content rate of the melting fiber is equal to or higher than the lower limit of the above range, it is easy to process the nonwoven fabric into any shape. In a case where the content rate of the melting fiber is equal to or lower than the upper limit of the above range, it is easy to inhibit the deterioration of the noise-absorbing and -insulating performance brought about by the melting fiber contained in the nonwoven fabric.

For example, the nonwoven fabric of the present embodiment preferably contains 10% to 90% by mass of the modified cross-section fiber and 10% to 40% by mass of the melting fiber, and the total content of the modified cross-section fiber and the melting fiber is preferably 20% to 100% by mass. Furthermore, the nonwoven fabric preferably contains 30% to 80% by mass of the modified cross-section fiber and 20% to 35% by mass of the melting fiber, and the total content of the modified cross-section fiber and the melting fiber is preferably 50% to 100% by mass.

The basis weight of the nonwoven fabric of the present embodiment is preferably 100 to 600 g/m². In a case where the basis weight of the nonwoven fabric is equal to or higher than 100 g/m², the noise-absorbing and -insulating performance tends to be improved. In a case where the basis weight is equal to or lower than 600 g/m², excellent formability is obtained, and the cost is reduced. From these viewpoints, the basis weight of the nonwoven fabric is more preferably 200 to 550 g/m², and even more preferably 300 to 500 g/m².

The thickness of the nonwoven fabric of the present embodiment is preferably 3 to 30 mm. In a case where the thickness of the nonwoven fabric is equal to or greater than 3 mm, the noise-absorbing and -insulating performance tends to be improved. In a case where the thickness is equal to or smaller than 30 mm, a highly versatile nonwoven fabric that can be used even in a small void is obtained. From these viewpoints, the thickness of the nonwoven fabric is more preferably 5 to 25 mm, and even more preferably 8 to 20 mm.

It is preferable that the nonwoven fabric of the present embodiment have a transmission loss equal to or higher than 5.1 dB at a frequency of 400 to 5,000 Hz.

In a case where the average of the transmission loss is equal to or higher than 5.1 dB, it is easy to obtain an excellent effect as noise-absorbing and -insulating performance. From this viewpoint, the average of the transmission loss is more preferably equal to or higher than 5.3 dB, even more preferably equal to or higher than 5.5 dB, and particularly preferably equal to or higher than 5.7 dB. In a case where the upper limit of the average of the transmission loss is 20 dB, the noise-absorbing and -insulating effect is fully exerted. Even though the upper limit is equal to or lower than 15 dB, an excellent effect is obtained. Even though the upper limit is equal to or lower than 10 dB, the effect is still exerted.

From these viewpoints, the transmission loss is preferably 5.1 to 20 dB, more preferably 5.3 to 20 dB, even more preferably 5.5 to 20 dB, and particularly preferably 5.7 to 20 dB.

The transmission loss may be 5.1 to 15 dB, 5.3 to 15 dB, 5.5 to 15 dB, or 5.7 to 15 dB. The transmission loss may be 5.1 to 10 dB, 5.3 to 10 dB, 5.5 to 10 dB, or 5.7 to 10 dB. For example, the thicker the nonwoven fabric is, the higher the average of the transmission loss tends to be. Furthermore, the higher the basis weight of the nonwoven fabric is, the higher the average of the transmission loss tends to be.

### Third Embodiment: Noise-Absorbing and -Insulating Material

The noise-absorbing and -insulating material of the present embodiment contains 10% by mass or more of the modified cross-section fiber of the first embodiment. In order to impart various performances to the noise-absorbing and -insulating material, fibers or members other than the modified cross-section fiber may be incorporated into the noise-absorbing and -insulating material.

The noise-absorbing and -insulating material of the present embodiment is, for example, in the form of a nonwoven fabric or a laminate of nonwoven fabrics.

In a case where the content rate of the modified cross-section fiber is equal to or higher than 10% by mass with respect to the total mass of the noise-absorbing and -insulating material, the noise-absorbing and -insulating performance brought about by the modified cross-section fiber contained in the noise-absorbing and -insulating material is effectively and fully improved. From the viewpoint of noise-absorbing and -insulating performance, it is preferable that the content rate of the modified cross-section fiber be high. The content rate of the modified cross-section fiber may be 100% by mass. The content rate of the modified cross-section fiber in the noise-absorbing and -insulating material is preferably 10% to 100% by mass, more preferably 20% to 100% by mass, and even more preferably 30% to 100% by mass.

The content rate of the modified cross-section fiber in the noise-absorbing and -insulating material may be 10% to 90% by mass or 1% to 70% by mass.

The content rate of the modified cross-section fiber in the noise-absorbing and -insulating material may be 30% to 90% by mass or 30% to 70% by mass.

The content rate of the modified cross-section fiber in the noise-absorbing and -insulating material may be 50% to 90% by mass or 50% to 70% by mass.

Furthermore, the noise-absorbing and -insulating material of the present embodiment and a member other than a nonwoven fabric may be combined and used in the form of a complex. The member other than a nonwoven fabric may or may not have noise-absorbing and -insulating performance. For example, as long as the desired noise-absorbing and -insulating performance is obtained, a film, a sheet, a resin layer, or the like may be laminated on the noise-absorbing and -insulating material of the present embodiment.

### Fourth Embodiment: Noise-Absorbing and -Insulating Material

The noise-absorbing and -insulating material of the present embodiment contains 50% by mass or more of the nonwoven fabric of the second embodiment. In order to impart various performances to the noise-absorbing and -insulating material, a member other than the nonwoven fabric of the second embodiment may be incorporated into the noise-absorbing and -insulating material.

The noise-absorbing and -insulating material of the present embodiment is, for example, in the form of the nonwoven fabric of the second embodiment, a laminate of the nonwoven fabric of the second embodiment and another nonwoven fabric, or a complex of the nonwoven fabric of the second embodiment and a member other than a nonwoven fabric.

In a case where the content rate of the nonwoven fabric of the second embodiment is equal to or higher than 50% by mass with respect to the total mass of the noise-absorbing and -insulating material, the noise-absorbing and -insulating performance brought about by the nonwoven fabric of the second embodiment contained in the noise-absorbing and -insulating material is effectively and fully improved. From the viewpoint of noise-absorbing and -insulating performance, it is preferable that the content rate of the modified cross-section fiber be high. The content rate of the modified cross-section fiber may be 100% by mass.

The member other than a nonwoven fabric may or may not have noise-absorbing and -insulating performance. For example, as long as the desired noise-absorbing and -insulating performance is obtained, a film, a sheet, a resin layer, or the like may be laminated on the nonwoven fabric of the second embodiment.

### EXAMPLES

Hereinafter, the present invention will be more specifically described with reference to examples. In the examples, each item was measured by the following method.

(Method of Measuring Single Fiber Fineness)

A single fiber fineness was measured using an automatic vibratory fineness tester (DeniorComputerDC-11 manufactured by Search Control Electric Co., Ltd.) under the conditions of a temperature of 25° C. and a humidity of 65%. The fineness was measured 25 times, and the average thereof was adopted as the measured value of single fiber fineness.

(Method of Measuring Non-Circularity Degree α of Fiber and the Like)

The fiber was cut in a direction perpendicular to the fiber axis, thereby obtaining a fiber cross section. By using an ion coater (IB-3 manufactured by EIKO ENGINEERING), Au was vapor-deposited on the fiber cross section, and then the fiber cross section was imaged using a scanning electron microscope (S-3500N, manufactured by Hitachi, Ltd.) at 2,000× magnification. The obtained image was processed using an area measurement program (Quick Grain), and a cross-sectional area A and a peripheral length P were measured. The equivalent circular diameter was calculated from the cross-sectional area A and adopted as “diameter” of the fiber. By using the values of A and P, modified cross-section degree was calculated by Equation (1) described above. The non-circularity degree was calculated for 10 samples, and the average thereof was adopted as a measured value of modified cross-section degree α.

(Method of Measuring Transmission Loss and Noise Absorption Coefficient)

Based on ASTM E2611, a transmission loss in a predetermined frequency range was measured. Based on JIS A 1405-2, a noise absorption coefficient in a predetermined frequency range was measured. As a measurement device, WinZac manufactured by Nihon Onkyo Engineering Co., Ltd. was used.

### Example 1

By aqueous suspension polymerization, a copolymer consisting of 93% by mass of acrylonitrile units and 7% by mass of vinyl acetate units was obtained. The reduced viscosity of the diluted solution (0.5%) of this copolymer was 2.0.

The obtained copolymer was dissolved in dimethylacetamide, thereby obtaining a spinning dope having a copolymer concentration of 24% by mass.

The obtained spinning dope was discharged from a spinning nozzle into a coagulation bath, thereby obtaining a fibrous substance. As the coagulation bath, an aqueous solution at a temperature of 40° C. having a dimethylacetamide concentration of 50% was used. The discharge hole of the spinning nozzle was in a 6-lobed shape as shown in FIG. 1. The area of the discharge hole (opening area) A′ was 1,500 μm², and the non-circularity degree α′ was 2.25. The value of the spinning draft was 1.5. The obtained fibrous substance was further stretched fivefold in hot water at 95° C., washed, dried by a drying roll, and subjected to a thermal relaxation treatment in a pressurized steam atmosphere. Subsequently, the fibrous substance was stretched twofold with dry heat by using a dry-heat roller at 220° C. and mechanically crimped, thereby obtaining a fiber A having a single fiber fineness of 0.4 dtex.

The cross-sectional area, peripheral length, diameter, and non-circularity degree of the fiber A were measured by the methods described above. The results are shown in Table 1 (the same shall be applied hereinafter).

### Example 2

A fiber B was obtained in the same manner as in Example 1, except that the stretching ratio was changed to obtain a single fiber fineness of 0.6 dtex.

### Example 3

A fiber C was obtained in the same manner as in Example 1, except that a pinwheel-shaped discharge hole shown in FIG. 2 was used, and the fibrous substance was stretched to obtain a single fiber fineness of 0.4 dtex.

### Example 4

A fiber D was obtained in the same manner as in Example 1, except that a pinwheel-shaped discharge hole shown in FIG. 2 was used, and the fibrous substance was stretched to obtain a single fiber fineness of 0.6 dtex.

### Example 5

A fiber E was obtained in the same manner as in Example 1, except that a pinwheel-shaped discharge hole shown in FIG. 2 was used, and the fibrous substance was stretched to obtain a single fiber fineness of 0.2 dtex.

### Comparative Example 1

A fiber F was obtained in the same manner as in Example 1, except that the shape of the discharge hole of the spinning nozzle was changed to a circle (circle having a diameter of 35 μm), and the fibrous substance was stretched to obtain a single fiber fineness of 0.4 dtex.

### Comparative Example 2

A fiber G was obtained in the same manner as in Example 1, except that the shape of the discharge hole of the spinning nozzle was changed to a circle (circle having a diameter of 35 μm), and the fibrous substance was stretched to obtain a single fiber fineness of 0.6 dtex.

TABLE 1

| | | Single | | | | | |
|---|---|---|---|---|---|---|---|
| | | fiber | | Peripheral | | | |
| | Cross-sectional | fineness | Cross-sectional | length P | Diameter | Non-circularity | Fiber |
| | shape of fiber | (dtex) | area A (μm²) | (μm) | (μm) | degree α | name |
| Example 1 | 6-Lobed | 0.4 | 43.1 | 57.4 | 7.41 | 2.47 | Fiber A |
| Example 2 | 6-Lobed | 0.6 | 47.1 | 61.0 | 7.74 | 2.51 | Fiber B |
| Example 3 | Pinwheel-shaped | 0.4 | 33.6 | 40.7 | 6.54 | 1.98 | Fiber C |
| Example 4 | Pinwheel-shaped | 0.6 | 48.6 | 52.3 | 7.87 | 2.12 | Fiber D |
| Example 5 | Pinwheel-shaped | 0.2 | 17.9 | 31.6 | 4.77 | 2.11 | Fiber E |
| Comparative | Circular | 0.4 | 39.4 | 24.0 | 7.08 | 1.08 | Fiber F |
| Example 1 | | | | | | | |
| Comparative | Circular | 0.6 | 51.0 | 26.9 | 8.06 | 1.09 | Fiber G |
| Example 2 | | | | | | | |

### Examples 6 to 9

For the fibers A to D, a noise absorption coefficient was measured by the same method as that in the noise-absorbing and -insulating performance test (I). Here, the noise absorption coefficient was measured at a frequency of 315 to 4,000 Hz, and a noise absorption coefficient at 315 to 2,000 Hz, a noise absorption coefficient at 400 to 1,250 Hz, and a noise absorption coefficient at 1,600 to 4,000 Hz were each calculated.

The results are shown in Table 2. The values shown in the table are the average of the measured noise absorption coefficients of the 3 samples.

### Comparative Example 3

The noise absorption coefficient was measured in the same manner as in Example 6, except that the fiber A was changed to the fiber F. The results are shown in Table 2.

TABLE 2

| | | Sound absorption coefficient (noise-absorbing and -insulating | | |
|---|---|---|---|---|
| | | performance test (I)) | | |
| | | Average at 315 to | Average at 400 to | Average at 1,600 to |
| | Fiber name | 2,000 Hz | 1,250 Hz | 4,000 Hz |
| Example 6 | Fiber A | 0.55 | 0.48 | 0.97 |
| Example 7 | Fiber B | 0.49 | 0.42 | 0.96 |
| Example 8 | Fiber C | 0.58 | 0.52 | 0.98 |
| Example 9 | Fiber D | 0.51 | 0.44 | 0.96 |
| Comparative | Fiber F | 0.46 | 0.38 | 0.96 |
| Example 3 | | | | |

As is evident from the results in Table 2, at a frequency of 315 to 2,000 Hz and at a frequency of 400 to 1,250 Hz, the noise absorption coefficient of the fibers A to D of the examples was higher than the noise absorption coefficient of the fiber F of the comparative example, and at a frequency of 1,600 to 4,000 Hz, the noise absorption coefficient of the fibers A to D of the examples was equal to or higher than the noise absorption coefficient of the fiber F of the comparative example.

### Examples 10 to 13

For the fibers A to D, a noise absorption coefficient was measured by the same method as that in the noise-absorbing and -insulating performance test (II). Here, the noise absorption coefficient was measured at a frequency of 315 to 4,000 Hz, and a noise absorption coefficient at 315 to 2,000 Hz, a noise absorption coefficient at 400 to 1,250 Hz, and a noise absorption coefficient at 1,600 to 4,000 Hz were each calculated.

The results are shown in Table 3. The values shown in the table are the average of the noise absorption coefficients of the 3 samples.

### Comparative Example 4

A noise absorption coefficient was measured in the same manner as in Example 10, except that the fiber A was changed to the fiber F. The results are shown in Table 3.

TABLE 3

| | | Sound absorption coefficient (noise-absorbing and -insulating | | |
|---|---|---|---|---|
| | | performance test (II)) | | |
| | | Average at 315 to | Average at 400 to | Average at 1,600 to |
| | Fiber name | 2,000 Hz | 1,250 Hz | 4,000 Hz |
| Example 10 | Fiber A | 0.26 | 0.20 | 0.70 |
| Example 11 | Fiber B | 0.24 | 0.20 | 0.63 |
| Example 12 | Fiber C | 0.25 | 0.19 | 0.71 |
| Example 13 | Fiber D | 0.22 | 0.18 | 0.64 |
| Comparative | Fiber F | 0.19 | 0.15 | 0.56 |
| Example 4 | | | | |

As is evident from the results in Table 3, at all the frequencies of 315 to 2,000 Hz, 400 to 1,250 Hz, and 1,600 to 4,000 Hz, the noise absorption coefficient of the fibers A to D of the examples was higher than the noise absorption coefficient of the fiber F of the comparative example.

### Example 14

By mixing 70% by mass of the fiber A cut in a length of 40 mm with 30% by mass of a polyester melting fiber (single fiber fineness: 2.2 dtex, fiber length 51 mm, melting point: 110° C.), a mixed raw material was obtained. This material was heated at 170° C. for 20 minutes and then cooled, thereby obtaining a nonwoven fabric for test having a thickness of 20 mm and a basis weight of 200 g/m².

Specifically, 28.8 g of the mixed raw material was put in a container having a length of 200 mm, a width of 300 mm, and a height of 50 mm, compressed to a height of 20 mm, and subjected to hot forming, thereby obtaining the aforementioned nonwoven fabric.

For the obtained nonwoven fabric, a transmission loss and a noise absorption coefficient were measured by the same method as that in the noise-absorbing and -insulating performance test (III). The transmission loss and the noise absorption coefficient were measured at a frequency of 400 to 5,000 Hz, and a transmission loss and a noise absorption coefficient at 400 to 5,000 Hz, a transmission loss and a noise absorption coefficient at 400 to 1,250 Hz, and a transmission loss and a noise absorption coefficient at 1,600 to 4,000 Hz were each calculated. The results are shown in Table 4. The values shown in the table are the average of the transmission loss and noise absorption coefficient of the 3 samples.

### Examples 15 and 16

A nonwoven fabric for test was manufactured and a transmission loss and a noise absorption coefficient thereof were measured in the same manner as in Example 14, except that the fiber A was changed to the fibers C and D. The results are shown in Table 4.

### Comparative Example 17

A nonwoven fabric for test was manufactured and a transmission loss and a noise absorption coefficient thereof were measured in the same manner as in Example 14, except that the fiber A was changed to the fiber F. The results are shown in Table 4.

TABLE 4

| | | Noise-absorbing and -insulating performance | | | | | |
|---|---|---|---|---|---|---|---|
| | | test (III) for non-woven fabric | | | | | |
| | | Transmission loss (dB) | | Sound absorption coefficient | | | |
| | | Average at | Average at | Average at | Average at | Average at | Average at |
| | Fiber | 400 to | 400 to | 1,600 to | 400 to | 400 to | 1,600 to |
| | name | 5,000 Hz | 1,250 Hz | 4,000 Hz | 5,000 Hz | 1,250 Hz | 4,000 Hz |
| Example 14 | Fiber A | 5.89 | 4.45 | 7.11 | 0.48 | 0.18 | 0.74 |
| Example 15 | Fiber C | 5.50 | 4.01 | 6.73 | 0.49 | 0.19 | 0.76 |
| Example 16 | Fiber D | 5.18 | 4.01 | 6.06 | 0.49 | 0.22 | 0.73 |
| Comparative | Fiber F | 5.09 | 3.75 | 6.20 | 0.46 | 0.16 | 0.73 |
| Example 5 | | | | | | | |

As is evident from the results in Table 4, at a frequency of 400 to 5,000 Hz and at a frequency of 400 to 1,250 Hz, the transmission loss of the fibers A, C, and D of the examples was higher than the transmission loss of the fiber F of the comparative example.

Furthermore, at a frequency of 400 to 5,000 Hz and at a frequency of 400 to 1,250 Hz, the noise absorption coefficient of the fibers A, C, and D of the examples was higher than the noise absorption coefficient of the fiber F of the comparative example, and at a frequency of 1,600 to 4,000 Hz, the noise absorption coefficient of the fibers A, C, and D of the examples was equal to or higher than the noise absorption coefficient of the fiber F of the comparative example.

### INDUSTRIAL APPLICABILITY

The modified cross-section fiber of the present invention is suitable as a material of a nonwoven fabric having excellent noise-absorbing performance and excellent noise-insulating performance (noise-absorbing and -insulating performance).

The method for manufacturing a modified cross-section fiber of the present invention makes it possible to manufacture a modified cross-section fiber having a low fineness by direct spinning.

The nonwoven fabric of the present invention has excellent noise-absorbing and -insulating performance.

The noise-absorbing and -insulating material of the present invention has excellent noise-absorbing and -insulating performance.

What is claimed is:

1. A modified cross-section fiber having a single fiber fineness of 0.01 to 1.0 dtex and modified cross-section degree (α) of 1.5 to 4.0 at a fiber cross section taken along a direction perpendicular to a fiber axis,
wherein the non-circularity degree is calculated by Equation (1),
α=P/(4πA)^{1/2} (1)
in the equation, P is a peripheral length (unit: μm) of the fiber cross section, and A is an area of the fiber cross section (unit: μm²).

2. The modified cross-section fiber according to claim 1, wherein the area (A) of the fiber cross section is 0.5 to 100 μm², and the peripheral length (P) in the fiber cross section is 5 to 250 μm.

3. The modified cross-section fiber according to claim 1, wherein the fiber cross section is Y-shaped, cross-shaped, 6-lobed, 8-lobed, or pinwheel-shaped.

4. The modified cross-section fiber according to claim 1, which is a polyester fiber, a polypropylene fiber, a nylon fiber, an aramid fiber, an acrylic fiber, or a rayon fiber.

5. The modified cross-section fiber according to claim 1 having a noise absorption coefficient equal to or higher than 0.40 at a frequency of 400 to 1,250 Hz, wherein the noise absorption coefficient is measured in a noise-absorbing and -insulating performance test (I), the noise-absorbing and -insulating performance test (I) comprising:
cutting a fiber (0.81 g) in a length of 40 mm;
putting the cut fiber in a cylindrical holder having a diameter of 41.5 mm and a thickness of 30 mm;
measuring a normal incidence noise absorption coefficient at a frequency of 400 to 1,250 Hz; and
calculating an average of the coefficient.

6. The modified cross-section fiber according to claim 1 having a noise absorption coefficient equal to or higher than 0.17 at a frequency of 400 to 1,250 Hz, wherein the noise absorption coefficient is measured in a noise-absorbing and -insulating performance test (II), the noise-absorbing and -insulating performance test (II) comprising:
cutting a fiber (0.27 g) in a length of 40 mm;
putting the cut fiber in a cylindrical holder having a diameter of 41.5 mm and a thickness of 20 mm;
measuring a normal incidence noise absorption coefficient at a frequency of 400 to 1,250 Hz; and
calculating an average of the coefficient.

7. The modified cross-section fiber according to claim 1 having a transmission loss equal to or higher than 5.1 dB at a frequency of 400 to 5,000 Hz, wherein the transmission loss is measured in a noise-absorbing and -insulating performance test (III), the noise-absorbing and -insulating performance test (III) comprising:
mixing the modified cross-section fiber (70% by mass) having a fiber length of 40 mm with 30% by mass of a polyester melting fiber having a single fiber fineness of 2.2 dtex, a fiber length of 51 mm, and a melting point of 110° C.;
heating the mixture at 170° C. for 20 minutes; and
cooling the mixture so that a nonwoven fabric for test having a thickness of 10 mm and a basis weight of 480 g/m² is obtained,
measuring a normal incidence transmission loss of the obtained nonwoven fabric for test at a frequency of 400 to 5,000 Hz; and
calculating an average of the normal incidence transmission loss.

8. A method for manufacturing a modified cross-section fiber, comprising:
obtaining a fibrous substance by discharging of a fiber raw material from a discharge hole which has a discharge hole area of 100 to 3,000 μm² and has a shape satisfying modified cross-section degree (α′) of 1.5 to 4.0 calculated by Equation (2); and
setting a single fiber fineness of the fibrous substance to be 0.01 to 1.0 dtex,
α′=P′/(4πA′)^{1/2} (2)
in the equation, P′ is a peripheral length (unit: μm) of the shape of the discharge hole, and A′ is the discharge hole area (unit: μm²).

9. A nonwoven fabric comprising 10% by mass or more of the modified cross-section fiber according to claim 1.

10. The nonwoven fabric according to claim 9 having a basis weight of 100 to 500 g/m² and a thickness of 3 to 30 mm.

11. The nonwoven fabric according to claim 9 having an average normal incidence transmission loss equal to or higher than 5.1 dB at a frequency of 400 to 5,000 Hz.

12. The nonwoven fabric according to claim 9, comprising 10% to 90% by mass of the modified cross-section fiber and 10% to 40% by mass of a melting fiber, wherein a total content of the modified cross-section fiber and the melting fiber is 20% to 100% by mass.

13. A noise-absorbing and -insulating material comprising 10% by mass or more of the modified cross-section fiber according to claim 1.

14. A noise-absorbing and -insulating material comprising 50% by mass or more of the nonwoven fabric according to claim 9.

15. The modified cross-section fiber according to claim 2, wherein the fiber cross section is Y-shaped, cross-shaped, 6-lobed, 8-lobed, or pinwheel-shaped.

16. The modified cross-section fiber according to claim 2, which is a polyester fiber, a polypropylene fiber, a nylon fiber, an aramid fiber, an acrylic fiber, or a rayon fiber.

17. The modified cross-section fiber according to claim 3, which is a polyester fiber, a polypropylene fiber, a nylon fiber, an aramid fiber, an acrylic fiber, or a rayon fiber.

18. The modified cross-section fiber according to claim 2 having a noise absorption coefficient equal to or higher than 0.40 at a frequency of 400 to 1,250 Hz, wherein the noise absorption coefficient is measured in a noise-absorbing and -insulating performance test (I), the noise-absorbing and -insulating performance test (I) comprising:
cutting a fiber (0.81 g) in a length of 40 mm;
putting the cut fiber in a cylindrical holder having a diameter of 41.5 mm and a thickness of 30 mm;
measuring a normal incidence noise absorption coefficient at a frequency of 400 to 1,250 Hz; and
calculating an average of the coefficient.

19. The modified cross-section fiber according to claim 2 having a noise absorption coefficient equal to or higher than 0.17 at a frequency of 400 to 1,250 Hz, wherein the noise absorption coefficient is measured in a noise-absorbing and -insulating performance test (II), the noise-absorbing and -insulating performance test (II) comprising:
cutting a fiber (0.27 g) in a length of 40 mm;
putting the cut fiber in a cylindrical holder having a diameter of 41.5 mm and a thickness of 20 mm;
measuring a normal incidence noise absorption coefficient at a frequency of 400 to 1,250 Hz; and
calculating an average of the coefficient.

20. The modified cross-section fiber according to claim 2 having a transmission loss equal to or higher than 5.1 dB at a frequency of 400 to 5,000 Hz, wherein the transmission loss is measured in a noise-absorbing and -insulating performance test (III), the noise-absorbing and -insulating performance test (III) comprising:
mixing the modified cross-section fiber (70% by mass) having a fiber length of 40 mm with 30% by mass of a polyester melting fiber having a single fiber fineness of 2.2 dtex, a fiber length of 51 mm, and a melting point of 110° C.;
heating the mixture at 170° C. for 20 minutes; and
cooling the mixture so that a nonwoven fabric for test having a thickness of 10 mm and a basis weight of 480 g/m² is obtained,
measuring a normal incidence transmission loss of the obtained nonwoven fabric for test at a frequency of 400 to 5,000 Hz; and
calculating an average of the normal incidence transmission loss.
